(19) United States
(12) Patent Application Publication
(10) Pub. No.: US 2010/0026375 A1
(43) Pub. Date: Feb. 4, 2010

(54) CIRCUIT TO GENERATE CMOS LEVEL SIGNAL TO TRACK CORE SUPPLY VOLTAGE (VDD) LEVEL

(75) Inventors: Rajesh Yadav, Ahmedabad (IN); Rajat Chauhan, Dehradun (IN)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/181,334

(22) Filed: Jul. 29, 2008

(51) Int. Cl. G05F 1/10

(52) U.S. Cl. 327/537

(57) ABSTRACT

A method, system, and apparatus circuit to generate CMOS level signal to track core supply voltage (VDD) level are disclosed. In one embodiment, a system of an integrated circuit includes an HHV generation circuit located in the integrated circuit to provide an HHV voltage signal to a subsystem circuit of the integrated circuit to replace a core voltage signal used by the subsystem circuit when the core voltage signal is below a specified value, an core voltage source located within the integrated circuit to provide the core voltage signal to the HHV generation circuit, and an external voltage source to provide an external voltage signal of an other entity located outside the integrated circuit to the HHV generation circuit. The system may include a pad driver circuit configured to associate the integrated circuit with the other entity.

### FIELD OF TECHNOLOGY

This disclosure relates generally to an enterprise method, a technical field of software and/or hardware technology and, in one example embodiment, a method to circuit to generate CMOS level signal to track core supply voltage (VDD) level.

### BACKGROUND

An integrated circuit may have an interface (e.g., an I/O interface, a CMOS, etc.) between a core voltage (e.g., VDD) and an external voltage (e.g., VDDS). A core voltage value may not match an external voltage value. The interface may include an inverter. During a ramp up phase of activation of the integrated circuit, a positive transistor and a negative transistor of the inverter may both be activated due to an intermediate voltage value. Consequently, a short circuit may occur that may damage (e.g., physically damage a metal component due to a threshold joule heat value in inverter) the interface.

An HHV component may be coupled to the interface in order to prevent the short circuit during the ramp up phase. However, the HHV component may consume a pin of the integrated circuit. Thus, the HHV may use valuable space on the integrated circuit that could be used for another device. Also, the HHV may be off the integrated circuit. Consequently, a user and/or external control module may be required to monitor the HHV. This may use valuable board space and/or require extra components that may increase the cost of designing and/or manufacturing the integrated circuit. Furthermore, the HHV may require an additional number of logic connections within the integrated. The additional number of logical connection may increase the complexity of a design of the integrated circuit and may use valuable space within the integrated circuit.

### SUMMARY

A method, system, and apparatus circuit to generate CMOS level signal to track core supply voltage (VDD) level are disclosed. In one aspect, a system of an integrated circuit includes an HHV generation circuit located in the integrated circuit to provide an HHV voltage signal to a subsystem circuit of the integrated circuit to replace a core voltage signal (e.g., may be VDD) used by the subsystem circuit when the core voltage signal is below a specified value, an core voltage source located within the integrated circuit to provide the core voltage signal to the HHV generation circuit, and an external voltage source to provide an external voltage signal (e.g., may be VDDS) of an other entity (e.g., may be other integrated circuit, other device on pad, etc.) located outside the integrated circuit to the HHV generation circuit.

The subsystem circuit may be a p-channel metal-oxide-semiconductor field-effect transistor (MOSFET) pre-driver logic circuit. In addition, the subsystem circuit may be an n-channel MOSFET pre-driver logic circuit. The subsystem circuit may also be a level shifter circuit (e.g., may be a voltage source of the pad driver circuit) that may convert the core voltage signal to the external voltage signal.

The system may include a pad driver circuit configured to associate the integrated circuit with the other entity (e.g., may be other integrated circuit, other device on PAD, etc.). The HHV generation circuit may generate an HHV voltage with a value equal to an external voltage value if a core voltage value is less than a specified voltage value. The HHV generation circuit may also generate the HHV voltage with the value equal to a zero value and a negative pin voltage value if the core voltage value is greater than the specified voltage value.

In another aspect, a method of an integrated circuit includes configuring an HHV generation circuit located in the integrated circuit to generate an HHV voltage signal with a voltage value equal to at least one of a zero value and a negative pin voltage value during a normal mode of operation of the integrated circuit, configuring the HHV generation circuit to generate the HHV voltage signal with the voltage value equal to an external voltage value during at least one of a ramp up mode of operation of the integrated circuit and when an internal voltage value is less than a specified nominal operating value, and communicating the HHV voltage signal to a subsystem circuit of the integrated circuit.

The subsystem circuit may be a p-channel metal-oxide-semiconductor field-effect transistor (MOSFET) pre-driver logic circuit. In addition, the subsystem circuit may be an n-channel MOSFET pre-driver logic circuit. The subsystem circuit may also be a level shifter circuit that may convert the voltage value to the external voltage value. The level shifter circuit may be a voltage source of a pad driver circuit configured to associate the integrated circuit with an other entity (e.g., may be other integrated circuit, other device on pad, etc.).

In yet another aspect, an apparatus of an integrated circuit includes an external voltage source, an core voltage source, a negative pin voltage source, a current circuit coupled with the external voltage source, the core voltage source and the negative pin voltage source to produce a current of a specified value, a control circuit coupled to a specified node to control a voltage value of the specified node, a current mirror circuit to copy the current produced by the current circuit and to communicate the current to the specified node, and an inverter circuit configured to receive an input voltage value from the specified node and generate an output voltage with a value equal to at least one of a voltage value of the external voltage source when an n-channel MOSFET of the control circuit is in an off state and an other voltage value of the negative pin voltage source when the n-channel MOSFET of the control circuit is in an on state.

The inverter circuit may communicate the output voltage to a p-channel MOSFET pre-driver logic circuit. In addition, the inverter circuit may communicate the output voltage to an n-channel MOSFET pre-driver logic circuit. The inverter circuit may also communicate the output voltage to a level shifter circuit. The inverter circuit may include an inversion circuit coupled in series with a Complementary metal-oxide-semiconductor (CMOS) circuit coupled in series with an other CMOS circuit.

The inversion circuit may include the external voltage source, an other p-channel MOSFET, a pair of n-channel MOSFETs and/or the negative pin voltage source coupled in series. The other p-channel MOSFET and/or the pair of n-channel MOSFETs may be coupled to an other node coupling the CMOS circuit with the other CMOS circuit in order to improve transient response during a power ramp up mode of operation of the integrated circuit. The CMOS circuit and the other CMOS circuit may be separately coupled to the external voltage source and the negative pin voltage source.

The control circuit may be an n-channel MOSFET coupled to the core voltage source and the negative pin voltage source. The specified node may charge to the external voltage source voltage value when a core voltage value is less than a threshold value voltage required for the n-channel MOSFET of the control circuit to be in an on-state. The specified node may charge to a negative pin voltage source voltage value when the core voltage value is equivalent and/or greater than the threshold value voltage required for the n-channel MOSFET of the control circuit to be in an on-state.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a systematic view of an integrated circuit communicating with other entity, according to one embodiment.

FIG. 2 is a diagrammatic view of an integrated chip illustrating input-output ring, rails, and an internal HHV generation circuit, according to one embodiment.

FIG. 3 is a systematic view illustrating a level shifter circuit that may use HHV signal (e.g., to avoid short circuit) to convert core voltage to external voltage driven by driver circuits, according to one embodiment.

FIG. 4 is a schematic view of a level shifter circuit that may include a current circuit mirroring a current in a current mirror circuit to generate a HHV voltage signal using an inversion circuit, an inverter circuit, and a control circuit, according to one embodiment.

FIG. 5 is a process flow for configuring an HHV generation circuit to generate an HHV voltage signal and communicate the HHV voltage signal to a subsystem circuit of the integrated circuit, according to one embodiment.

Other features of the present embodiments will be apparent from the accompanying drawings and from the detailed description that follows.

### DETAILED DESCRIPTION

A method, system, and apparatus to circuit to generate CMOS level signal to track core supply voltage (VDD) level are disclosed. Although the present embodiments have been described with reference to specific example embodiments, it will be evident that various modifications and changes may be made to these embodiments without departing from the broader spirit and scope of the various embodiments.

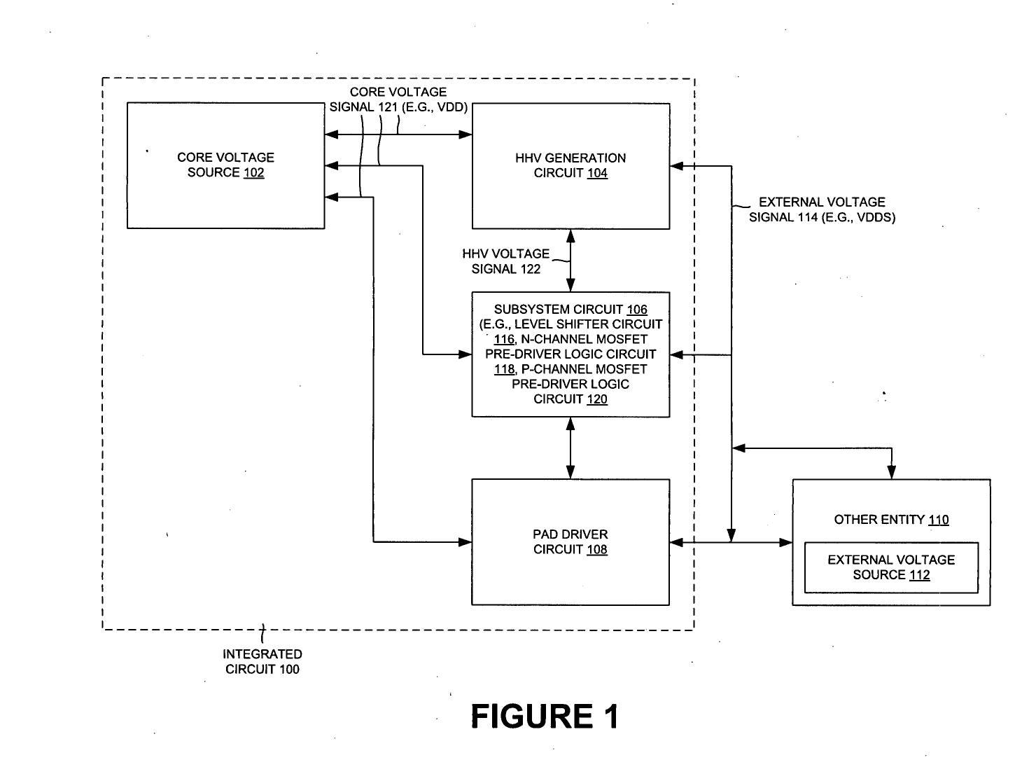

In one embodiment, a system of an integrated circuit (e.g., the integrated circuit 100 of FIG. 1) includes an HHV generation circuit (e.g., the HHV generation circuit 104 of FIG. 1) located in the integrated circuit 100 to provide an HHV voltage signal (e.g., the HHV voltage signal 122 of FIG. 1) to a subsystem circuit (e.g., the subsystem circuit 106 of FIG. 1) of the integrated circuit 100 to replace a core voltage signal (e.g., the core voltage signal 121 of FIG. 1) used by the subsystem circuit 106 (e.g., may be level shifter circuit 116, N-channel MOSFET pre-driver logic circuit, p-channel MOSFET pre-driver logic circuit, etc.) when the core voltage signal 121 (e.g., may be VDD) is below a specified value, an core voltage source (e.g., the core voltage source 102 of FIG. 1) located within the integrated circuit 100 to provide the core voltage signal 121 (e.g., may be VDD) to the HHV generation circuit 104, and an external voltage source (e.g., the external voltage source 112 of FIG. 1) to provide an external voltage signal (e.g., the external voltage signal 114 of FIG. 1) of an other entity (e.g., the other entity 110 of FIG. 1) (e.g., may be other integrated circuit, other device on pad, etc.) located outside the integrated circuit 100 to the HHV generation circuit 104.

In another embodiment, a method of an integrated circuit (e.g., the integrated circuit 100 of FIG. 1) includes configuring an HHV generation circuit (e.g., the HHV generation circuit 104 of FIG. 1) located in the integrated circuit 100 to generate an HHV voltage signal (e.g., the HHV voltage signal 122 of FIG. 1) with a voltage value equal to at least one of a zero value and a negative pin voltage value during a normal mode of operation of the integrated circuit 100, configuring the HHV generation circuit 104 to generate the HHV voltage signal 122 with the voltage value equal to an external voltage value during at least one of a ramp up mode of operation of the integrated circuit 100 and when an internal voltage value is less than a specified nominal operating value, and communicating the HHV voltage signal 122 to a subsystem circuit (e.g., the subsystem circuit 106 of FIG. 1) of the integrated circuit 100.

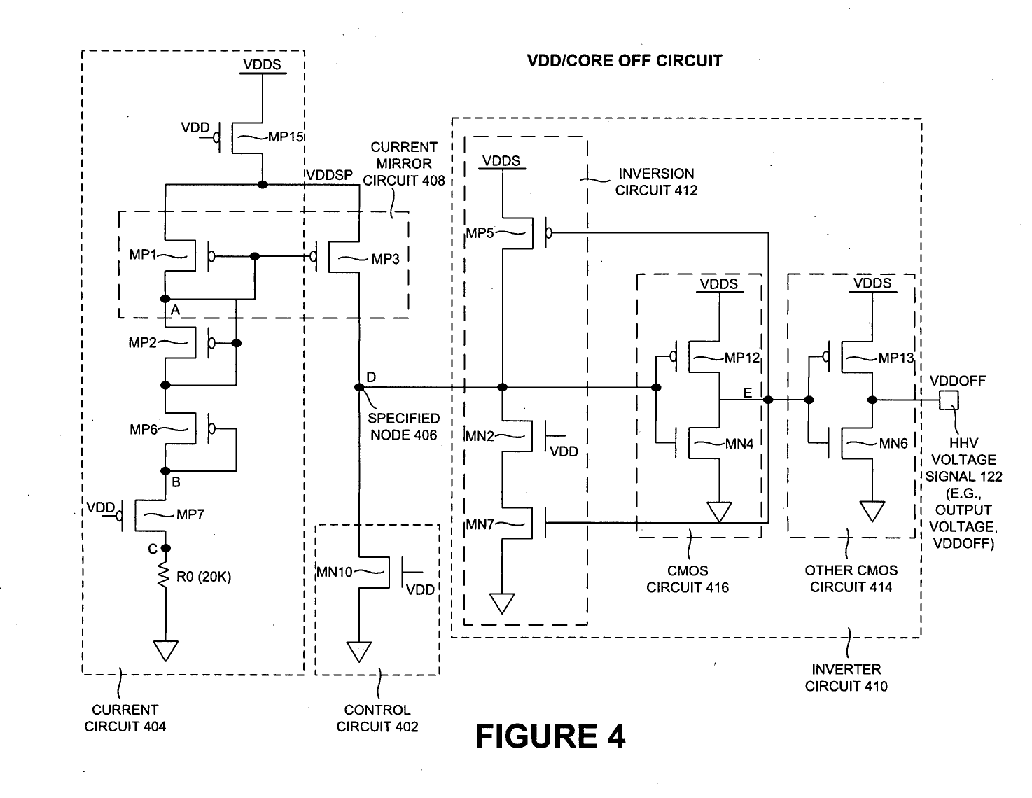

In yet another embodiment, an apparatus of an integrated circuit (e.g., the integrated circuit 100 of FIG. 1) includes an external voltage source (e.g., the external voltage source 112 of FIG. 1), an core voltage source (e.g., the core voltage source 102 of FIG. 1), a negative pin voltage source, a current circuit (e.g., the current circuit 404 of FIG. 4) coupled with the external voltage source 112, the core voltage source 102 and the negative pin voltage source to produce a current of a specified value, a control circuit (e.g., the control circuit 402 of FIG. 4) coupled to a specified node (e.g., the specified node 406 of FIG. 4) to control a voltage value of the specified node 406, a current mirror circuit (e.g., the current mirror circuit 408 of FIG. 4) to copy the current produced by the current circuit 404 and to communicate the current to the specified node 406, and an inverter circuit (e.g., the inverter circuit 410 of FIG. 4) configured to receive an input voltage value from the specified node 406 and generate an output voltage with a value equal to at least one of a voltage value of the external voltage source 112 when an n-channel MOSFET of the control circuit 402 is in an off state and an other voltage value of the negative pin voltage source when the n-channel MOSFET of the control circuit 402 is in an on state.

FIG. 1 is a systematic view of an integrated circuit communicating with other entity, according to one embodiment. Particularly, FIG. 1 illustrates an integrated circuit 100, a core voltage source 102, a HHV generation circuit 104, a subsystem circuit 106, a pad driver circuit 108, an other entity 110, an external voltage source 112, an external voltage signal 114, a level shifter circuit 116, a n-channel MOSFET pre-driver logic circuit 118, a p-channel MOSFET pre-driver logic circuit 120, a core voltage signal 121, and an HHV voltage signal 122 according to one embodiment.

The integrated circuit 100 (e.g., microchip, a field-programmable gate array, microprocessor, timer, etc.) may be a semiconductor wafer in which the components (e.g., active, passive, and/or other electronic components, etc.) may be fabricated. The core voltage source 102 may be a source device that may generate an electrical energy (e.g., voltage, VDD, etc.) which may be located in the integrated circuit 100 (e.g., by supplying the voltage from external source) that may provide the core voltage signal 121 to the internal components (e.g., HHV generation circuit 104, and/or other circuits, etc.).

The HHV generation circuit 104 may be a circuit located within the integrated circuit 100 (e.g., micro-chip, timer, etc.) that may provide the HHV voltage signal 122 to the subsystem circuit 106 (e.g., may be the level shifter circuit 116, etc.) that may replace the core voltage signal 121 when a core voltage value is less than a specified value. The subsystem circuit 106 may be a circuit (e.g., the level shifter circuit 116 made up of inverter circuit, etc.) which may be used to convert the core voltage signal 121 (e.g., VDD voltage, etc.) to the voltage (e.g., the external voltage, VDDS, etc.) that may be required by input-output interface.

The pad driver circuit 108 may be a circuit (e.g., output drivers, etc.) that may have a conductive platform (e.g., made up of copper, aluminum, etc.) which may be used to make electrical contacts to which components (e.g., a resistors, capacitors, etc.) may be connected (e.g., through soldering) in the integrated circuit 100. The pad driver circuit 108 may be configured to associate the integrated circuit 100 with the other entity 110. The other entity 110 may be circuits (e.g., may be the timer on chip, the memory device, the analog to digital converter, other device on pad, etc.) that may be associated with the integrated circuit 100 which may provide the external voltage signal 114 (e.g., may be VDDS, etc.) to the circuits (e.g., the HHV generation circuit 104, subsystem circuit 106, pad driver circuit 108, etc.) located on the integrated circuit 100.

The external voltage source 112 may be a device that may produce an electromotive force between the circuits (e.g., may be the circuits on the other entity 110 and/or the integrated circuit 100) that may provide the external voltage signal 114 (e.g., VDDS, etc.) to the components (e.g., the HHV generation circuit 104, etc.) of the integrated circuit 100 which may replace the core voltage signal 121(e.g., the VDD, etc.) when an external voltage value is less than a specified value. The external voltage signal 114 may be a voltage signal (e.g., VDDS, etc.) generated by the external voltage source 112 of the other entity 110 that may provide the required voltage value to Input-Output (I/O) interface of the integrated circuit 100.

The level shifter circuit 116 (e.g., may be made up of inverter circuit) may be a circuit used to convert the input voltage (e.g., core voltage signal 121, VDD voltage, etc.) to another voltage (e.g., the external voltage, VDDS, etc.). The n-channel MOSFET pre-driver logic circuit 118 may be a circuit that may include transistor (e.g., may be NMOS transistor, etc.) which may be a part of an inverter circuit (e.g., the inverter circuit 410 of FIG. 4) that may drive the other entity 110 (e.g., may be output drivers, etc.). The p-channel MOSFET pre-driver logic circuit 120 may be a circuit that may include transistor (e.g., may be PMOS transistor, etc.) which may be a part of the inverter circuit 410 that may drive the other entity 110 (e.g., may be output drivers, etc.).

The core voltage signal 121 may be a voltage signal transmitted within the core of the integrated circuit 100 to provide a voltage signal (e.g., VDD, etc.) to the HHV generation circuit 104, the subsystem circuit 106, the pad driver circuit 108, etc. The HHV voltage signal 122 may be a voltage signal generated by the HHV generation circuit 104 that may be provided to the subsystem circuit 106 (e.g., level shifter circuit 116, etc.) to avoid short circuit that may be caused due to indeterminate state at the pre-driver logic circuit.

In example embodiment, the integrated circuit 100 may include the core voltage source 102 communicating (e.g., may be the core voltage signal 121) with the HHV generation circuit 104, the subsystem circuit 106 (e.g., may be the level shifter circuit 116, the n-channel MOSFET pre-driver logic circuit 118, the p-channel MOSFET pre-driver logic circuit 120, etc.) and/or the pad driver circuit 108. The other entity 110 may communicate (e.g., may be the external voltage signal 114) to the pad driver circuit 108, the subsystem circuit 106, and the HHV generation circuit 104. The other entity 110 may include the external voltage source 112 that may generate the external voltage signal 114 (e.g., may be VDD, etc.). The HHV generation circuit 104 may communicate (e.g., may be the HHV voltage signal 122) with the subsystem circuit 106 that may communicate with the pad driver circuit 108.

In one embodiment, the HHV generation circuit 104 located in the integrated circuit 100 may provide the HHV voltage signal 122 to the subsystem circuit 106 of the integrated circuit 100 to replace the core voltage signal 121 (e.g., may be VDD, etc.) used by the subsystem circuit 106 when the core voltage signal 121 is below a specified value. The core voltage source 102 located within the integrated circuit 100 may provide the core voltage signal 121 to the HHV generation circuit 104. The external voltage source 112 may provide the external voltage signal 114 (e.g., may be VDDS, etc.) of the other entity 110 (e.g., may be other integrated circuit, other device on pad, etc.) located outside the integrated circuit 100 to the HHV generation circuit 104. The subsystem circuit 106 may be the p-channel metal-oxide-semiconductor field-effect transistor (MOSFET) pre-driver logic circuit 120. The subsystem circuit 106 may be the n-channel MOSFET pre-driver logic circuit 118.

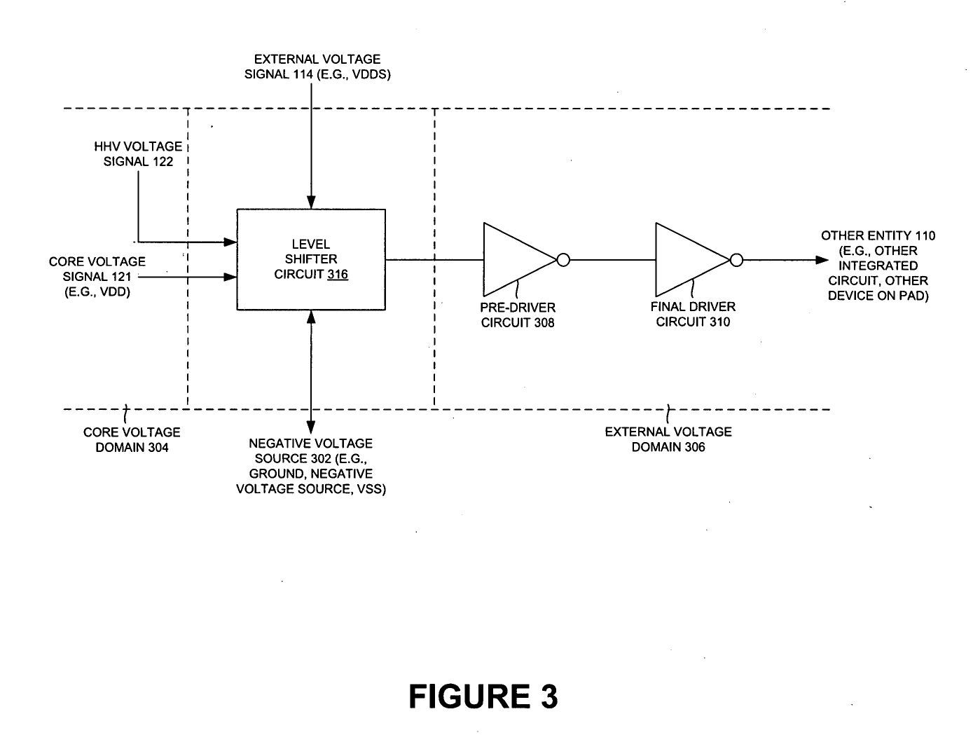

The subsystem circuit 106 may be level shifter circuit (e.g., may be the level shifter circuit 116 of FIG. 1 and/or the level shifter circuit 316 of FIG. 3) that may convert the core voltage signal 121 to the external voltage signal 114. The pad driver circuit 108 may be configured to associate the integrated circuit 100 with the other entity 110. The HHV generation circuit 104 may generate HHV voltage with a value equal to an external voltage value if a core voltage value is less than a specified voltage value. The HHV generation circuit 104 may generate HHV voltage with the value equal to a zero value and/or a negative pin voltage value if the core voltage value is greater than the specified voltage value.

The HHV generation circuit 104 located in the integrated circuit 100 may be configured to generate the HHV voltage signal 122 with a voltage value equal to a zero value and/or a negative pin voltage value during a normal mode of operation of the integrated circuit 100. The HHV generation circuit 104 may be configured to generate the HHV voltage signal 122 with the voltage value equal to an external voltage value during a ramp up mode of operation of the integrated circuit 100 and when an internal voltage value is less than a specified nominal operating value. The HHV voltage signal 122 may be configured to the subsystem circuit 106 of the integrated circuit 100.

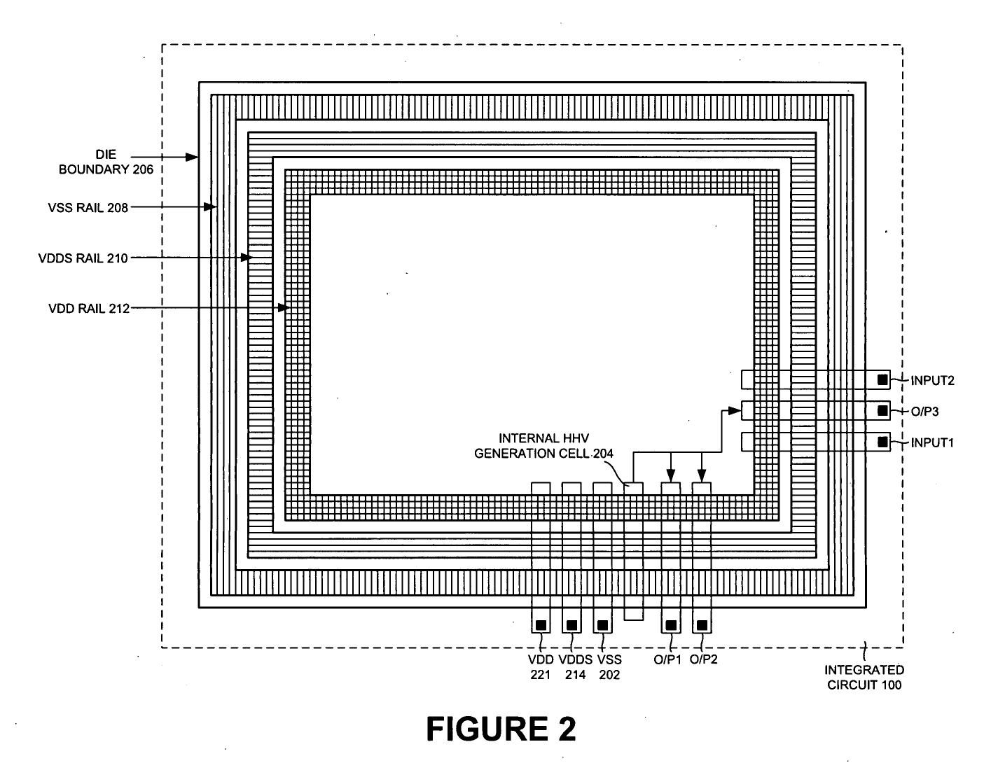

FIG. 2 is a diagrammatic view of an integrated chip illustrating I/O ring, rails, and an internal HHV generation circuit, according to one embodiment. Particularly, FIG. 2 illustrates a VSS 202, an internal HHV generation cell 204, a die boundary 206, a VSS rail 208, a VDDS rail 210, a VDD rail 212, a VDDS 214, and a VDD 221, according to one embodiment.

The VSS 202 may be a signal (e.g., voltage) obtained from a voltage source which may be given to the transistors (e.g., n-channel metal oxide semiconductor, etc.). The internal HHV generation cell 204 may be a circuit located inside the integrated circuit 100 to produce the HHV voltage signal 122 that may be given to the subsystem circuit 106 (e.g., may be the level shifter circuit 116, etc.) to replace the core voltage signal 121 when core voltage value is less than a specified value (e.g., may be a voltage value that may create a short circuit). The die boundary 206 may be a region located on the perimeter (e.g., boundary, border, etc.) of a chip that may exclude an oxide layer typically disposed between a dielectric layer and a substrate that may be used in the fabrication of the integrated circuit 100.

The VSS rail 208 may be a common region (e.g., a track, section, etc.) that may enable other components (e.g., may be components like NMOS transistor that may be included in the level shifter circuit 116, etc.) to draw power (e.g., negative voltage source 302). The VDDS rail 210 may be the common region (e.g., track, section, etc.) that may be required by input-output (I/O) interface of the integrated circuit 100 for maintaining driving capability. The VDD rail 212 may be the common region (e.g., area, track, etc.) that may draw power (e.g., may be the core voltage signal 121) which may be transmitted in the core of the integrated circuit 100 to provide voltage signal (e.g., VDD, etc.) to the HHV generation circuit 104.

The VDDS 214 may be a signal (e.g., voltage) obtained from external voltage source 112 that may be used to drive the input-output interface (e.g., may be the pad driver circuit 108) of the integrated circuit 100. The VDD 221 may be a signal (e.g., may be the core voltage signal 121) obtained from the core voltage source 102 (e.g., that may cause short circuit at an intermediate state) that may enable the operation of a level shifter circuit (e.g., the level shifter circuit 316 of FIG. 3).

In example embodiment, the integrated circuit 100 may include integrated chip that may include the VSS 202, the internal HHV generation cell 204, the die boundary 206, I/O ring, signal rails (e.g., the VSS rail 208, the VDDS rail 210, the VDD rail 212, etc.), the VDDS 214, and the VDD 221.

FIG. 3 is a systematic view illustrating a level shifter circuit that may use HHV signal (e.g., to avoid short circuit) to convert core voltage to external voltage which may be used to drive other entity, according to one embodiment. Particularly, FIG. 3 illustrates a negative voltage source 302, a core voltage domain 304, an external voltage domain 306, a pre-driver circuit 308, a final driver circuit 310, and a level shifter circuit 316, according to one embodiment.

The negative voltage source 302 may be a circuit (e.g., may be a source of voltage supply) that may provide voltage (e.g., VSS, etc.) which may be given to the transistor (e.g., n-channel metal oxide semiconductor, etc.). The core voltage domain 304 may be a circuit that may provide the core voltage signal 121 (e.g., VDD, etc.) which may be transmitted in the core of the integrated circuit 100 to provide a voltage signal (e.g., VDD, etc.) to the level shifter circuit 316. The external voltage domain 306 may include circuits in which voltage may be generated (e.g., from the level shifter circuit 316) that may be required to drive (e.g., using pre-driver and/or final driver circuit) the other entity 110 (e.g., other integrated circuit, timer circuit etc).

The pre-driver circuit 308 may be a circuit (e.g., may be an inverter circuit) that may be used to speed up the ramping process to control another circuit and/or other component (e.g., the final driver circuit 310, etc.). The final driver circuit 310 may be a circuit (e.g., may be an inverter circuit) that may be used to control (e.g., drive, manage, etc.) another circuit and/or other component (e.g., the other entity 110, high-power transistor, amplifiers, etc.). The level shifter circuit 316 may be used to convert the input voltage (e.g., the core voltage signal 121, VDD voltage, etc.) to another voltage (e.g., the external voltage, VDDS, etc.) that may be required by external voltage domain 306 (e.g., input-output interface, etc.).

In example embodiment, the level shifter circuit 316 may obtain the HHV voltage signal 122, the external voltage signal 114 (e.g., VDDS, etc.), and/or the core voltage signal 121 (e.g., may be VDD) from the core voltage domain 304. The level shifter circuit 316 may process the signals (e.g., HHV voltage signal 122, the core voltage signal 121, the external voltage signal 114, etc.) to drivers (e.g., may be the pre-driver circuit 308 and/or the final driver circuit 310) that may drive the other entity 110 (e.g., other integrated circuit, other device on pad, etc.).

In one embodiment, the level shifter circuit 316 may be a voltage source of the pad driver circuit 108 (e.g., the pad driver circuit 108 of FIG. 1) configured to associate the integrated circuit 100 with the other entity 110 (e.g., may be other integrated circuit, other device on pad, etc.).

FIG. 4 is a schematic view of a level shifter circuit that may include a current circuit mirroring a current in a current mirror circuit to generate a HHV voltage signal using an inversion circuit, an inverter circuit, and a control circuit, according to one embodiment. Particularly, FIG. 4 illustrates a control circuit 402, a current circuit 404, a specified node 406, a current mirror circuit 408, an inverter circuit 410, an inversion circuit 412, an other CMOS circuit 414, and a CMOS circuit 416, according to one embodiment.

The control circuit 402 may be a circuit made up of transistor (e.g., MN10) which may control the specified node 406 in the circuit that may put the output driver (e.g., NMOS, PMOS) in determinant (e.g., high impedance state). The current circuit 404 may be a circuit made up of transistors (e.g., MP15 may act as resister, MP2, MP6, MP7, resister RO, etc.) which may be a source providing current and connected to the inverter circuit 410 through the specified node 406.

The specified node 406 may be a node (e.g., D node) that may produce a determinate state (e.g., may be always close to VSS 202) to avoid short circuit in the integrated circuit 100. The current mirror circuit 408 may be a circuit made up of transistors (e.g., MP1 and/or MP3) to copy (e.g., to mirror) the current through one active device (e.g., the transistor MP1) by controlling the current in another active device (e.g., MP3) of the integrated circuit 100 which may keep the output current constant that may avoid loading. The inversion circuit 412 may be made up of transistors (e.g., MN2, MN5, and/or MN7) located on the inverter circuit 410 and/or may be coupled in series to the CMOS circuit 416 and the other CMOS circuit 414.

The other CMOS circuit 414 may be a logic circuit located on the inverter circuit 410 and connected to the CMOS circuit 416 by the other node from which the significant power may be drawn when the transistors in the CMOS device switch between on and off states and the CMOS circuit 416 may be a logic circuit located in the inverter circuit 410 from which the significant power may be drawn when the transistors in the CMOS device switch between on and off states.

In example embodiment, the current circuit may consist of the transistors (e.g., may be MP1, MP2, MP6, MP7, MP15, etc.) resistor RO, etc. connected to the inverter circuit 410 through the specified node 406. The current circuit 404 may be connected to the current mirror circuit made up of transistors (e.g., MP1, MP3, etc.). The mirrored current from the current mirror circuit 408 may be provided to the inverter circuit 410. The inverter circuit 410 may include the inversion circuit 412, the other CMOS circuit 414 and the CMOS circuit 416. The inversion circuit 412 may be made up of transistors (e.g., MN2, MP5, MN7, etc.). The CMOS circuit 416 may be made up of transistors (e.g., MN4, and/or MP12, etc.). The other CMOS circuit 414 may be made up of transistors (e.g., MN6, and/or MP13, etc.).

In another embodiment, in case of normal operation (e.g., when VDD may be present and/or is at nominal operating value), MN10 may be ON (e.g., gate may be connected to VDD) which may cause the specified node 406 to be at VSS (e.g., signal D is at VSS) which may result VDDOFF (e.g., as illustrated in FIG. 4) signal to be at VSS level. The current flow through the path defined by transistors MP15, MPI, (e.g., MP2 is a used in cap configuration to improve the transient response), MP6 and/or MP7 may be less when the transistor's voltage (e.g., MP15's VGS=VDD−VDDS, and MP7 VGS is effectively VDD+2*VTP−VDDS) which may limit the substantial current in this path (e.g., VTP+PMOS threshold voltage, VTN+NMOS threshold voltage).

When core voltage source 102 may be very low (e.g., VDD=OV) then the transistor (e.g., MN10) may be off when gate to source voltage (e.g., VGS) may be lesser then negative threshold voltage (e.g., VTN). The current path through the transistors (e.g., MP15, MPI, MP6, and MP7) may be mirrored through transistor (e.g., PI and/or MP3). The transistor (e.g., MP3) may pull up the specified node 406 (e.g., node D) to the external voltage signal 114 (e.g., VDDS) when the transistor (e.g., MN10) may be OFF which may change the signal (e.g., VDDOFF) to external voltage signal 114 (e.g., VDDS). The signal VDDOFF may be used in the level shifter circuit 316, and in the logic circuit to put the pre-driver circuit 308 and/or the final driver circuit 310 to the high impedance state. The transistors (e.g., MN2, MN7, and/or MP5) may show some hysteresis for the core voltage signal (e.g., VDD). The transition of the VDDOFF signal from VDDS to ‘0’ is governed by transistor MN10 when VDD may switch from low to high. VDD may reach VTN of MN10 when VDDOFF signal may switch to 0V. High to low ramp of VDD may have the transition of VDDOFF signal (e.g., may depend upon the VTP of MP7 and/or the current flowing through it).

In one embodiment, the current circuit 404 may be coupled with the external voltage source 112, the core voltage source 102 and/or the negative pin voltage source to produce a current of a specified value. The control circuit 402 may be coupled to the specified node 406 to control a voltage value of the specified node 406. The current mirror circuit 408 may copy the current produced by the current circuit 404 and/or may communicate the current to the specified node 406. The inverter circuit 410 may be configured to receive an input voltage value from the specified node 406.

The inverter circuit 410 may generate an output voltage with a value equal to voltage value of the external voltage source 112 (e.g., the external voltage source 112 of FIG. 1) when an n-channel MOSFET of the control circuit 402 is in an off state and an other voltage value of the negative pin voltage source when the n-channel MOSFET of the control circuit 402 is in an on state. The inverter circuit 410 may communicate the output voltage to a p-channel MOSFET pre-driver logic circuit. The inverter circuit 410 may communicate the output voltage to an n-channel MOSFET pre-driver logic circuit.

The inverter circuit 410 may communicate the output voltage to the level shifter circuit (e.g., the level shifter circuit 116 of FIG. 1 and/or the level shifter circuit 316 of FIG. 3). The inversion circuit 412 may be coupled in series with the Complementary metal-oxide-semiconductor (CMOS) circuit 416 coupled in series with the other CMOS circuit 414. The inversion circuit 412 may include the external voltage source 112, other p-channel MOSFET, a pair of n-channel MOSFETs and/or the negative pin voltage source coupled in series. The other p-channel MOSFET and the pair of n-channel MOSFETs may be coupled to other node coupling the CMOS circuit 416 with the other CMOS circuit 414 in order to improve transient response during a power ramp up mode of operation of the integrated circuit 100 (e.g., the integrated circuit 100 of FIG. 1).

The CMOS circuit 416 and the other CMOS circuit 414 may be separately coupled to the external voltage source 112 and the negative pin voltage source. The control circuit 402 may be an n-channel MOSFET coupled to the core voltage source 102 and the negative pin voltage source. The specified node 406 may charge to external voltage source 112 voltage value when a core voltage value is less than a threshold value voltage required for the n-channel MOSFET of the control circuit 402 to be in an on-state. The specified node 406 may charge to a negative pin voltage source voltage value when the core voltage value is equivalent and/or greater than the threshold value voltage required for the n-channel MOSFET of the control circuit 402 to be in an on-state.

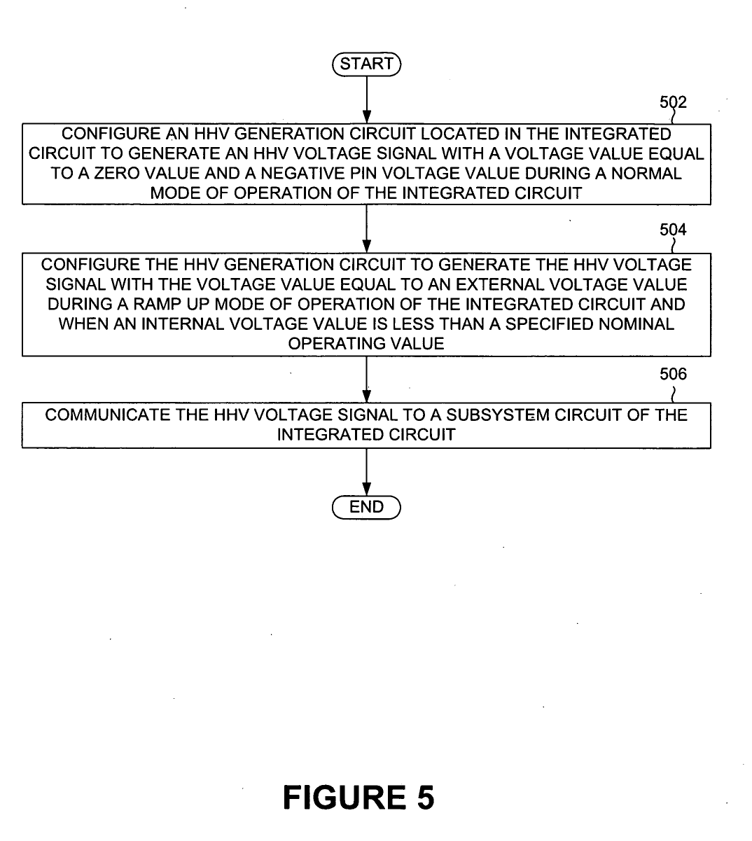

FIG. 5 is a process flow for configuring an HHV generation circuit to generate an HHV voltage signal and communicate the HHV voltage signal to a subsystem circuit of the integrated circuit, according to one embodiment. In operation 502, an HHV generation circuit (e.g., the HHV generation circuit 104 of FIG. 1) located in an integrated circuit (e.g., the integrated circuit 100 of FIG. 1) may be configured to generate an HHV voltage signal (e.g., the HHV voltage signal 122 of FIG. 1) with a voltage value equal to a zero value and/or a negative pin voltage value during a normal mode of operation of the integrated circuit 100.

In operation 504, the HHV generation circuit 104 may be configured to generate the HHV voltage signal 122 with the voltage value equal to an external voltage value during a ramp up mode of operation of the integrated circuit 100 and when an internal voltage value is less than a specified nominal operating value. In operation 506, the HHV voltage signal 122 may be communicated (e.g., using the rails as illustrated in FIG. 2) to a subsystem circuit (e.g., the subsystem circuit 106 of FIG. 1) of the integrated circuit 100. The subsystem circuit 106 may be a p-channel metal-oxide-semiconductor field-effect transistor (MOSFET) pre-driver logic circuit. The subsystem circuit 106 may be an n-channel MOSFET pre-driver logic circuit.

The subsystem circuit 106 may be a level shifter circuit 116 that may convert the voltage value (e.g., may be core voltage value) to the external voltage value. The level shifter circuit (e.g., the level shifter circuit 116 of FIG. 1 and/or the level shifter circuit 316 of FIG. 3) may be a voltage source of a pad driver circuit (e.g., the pad driver circuit 108 of FIG. 1) configured to associate the integrated circuit 100 with an other entity (e.g., the other entity 110 of FIG. 1) (e.g., may be other integrated circuit, other device on pad, etc.).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the integrated circuit 100, the HHV generation circuit, the subsystem circuit 106, the pad driver circuit 108, the level shifter circuit 116, the n-channel MOSFET pre-driver logic circuit 118, and the p-channel MOSFET pre-driver logic circuit 120 of FIG. 1, the level shifter circuit 316, the pre-driver circuit 308, and the final driver circuit of FIG. 3, and the control circuit 402, the current circuit 404, the current mirror circuit 408, the inverter circuit 410, the inversion circuit 412, the other CMOS circuit 414, and the CMOS circuit 416 may be enabled using software and/or using transistors, logic gates, and electrical circuits (e.g., application specific integrated ASIC circuitry).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

1. A system of an integrated circuit comprising:
an HHV generation circuit located in the integrated circuit to provide an HHV voltage signal to a subsystem circuit of the integrated circuit to replace a core voltage signal used by the subsystem circuit when the core voltage signal is below a specified value, wherein the HHV generation circuit senses current;
an core voltage source located within the integrated circuit to provide the core voltage signal to the HHV generation circuit; and
an external voltage source to provide a external voltage signal of an other entity located outside the integrated circuit to the HHV generation circuit.

2. The system of claim 1 wherein the subsystem circuit is a p-channel metal-oxide-semiconductor field-effect transistor (MOSFET) pre-driver logic circuit.

3. The system of claim 1 wherein the subsystem circuit is an n-channel MOSFET pre-driver logic circuit.

4. The system of claim 1 wherein the subsystem circuit is a level shifter circuit to convert the core voltage signal to the external voltage signal.

5. The system of claim 4 further comprising a pad driver circuit configured to associate the integrated circuit with the other entity.

6. The system of claim 5 wherein the level shifter circuit is a voltage source of the pad driver circuit.

7. The system of claim 1:
wherein the HHV generation circuit generates the HHV voltage with a value equal to an external voltage value if a core voltage value is less than a specified voltage value; and
wherein the HHV generation circuit generates the HHV voltage with the value equal to at least one of a zero value and a negative pin voltage value if the core voltage value is greater than the specified voltage value.

8. A method of an integrated circuit comprising:
configuring an HHV generation circuit located in the integrated circuit to generate an HHV voltage signal with a voltage value equal to at least one of a zero value and a negative pin voltage value during a normal mode of operation of the integrated circuit;
configuring the HHV generation circuit to generate the HHV voltage signal with the voltage value equal to an external voltage value during at least one of a ramp up mode of operation of the integrated circuit and when an internal voltage value is less than a specified nominal operating value; and
communicating the HHV voltage signal to a subsystem circuit of the integrated circuit, wherein configuring further comprises sensing current.

9. The method of claim 8 wherein the subsystem circuit is a p-channel metal-oxide-semiconductor field-effect transistor (MOSFET) pre-driver logic circuit.

10. The method of claim 8 wherein the subsystem circuit is an n-channel MOSFET pre-driver logic circuit.

11. The method of claim 8 wherein the subsystem circuit is a level shifter circuit to convert the voltage value to the external voltage value.

12. The method of claim 11 wherein the level shifter circuit is a voltage source of a pad driver circuit configured to associate the integrated circuit with an other entity.

13. A apparatus of an integrated circuit, comprising:
an external voltage source;
an core voltage source;
a negative pin voltage source;
a current circuit coupled with the external voltage source, the core voltage source and the negative pin voltage source to produce a current of a specified value;
a control circuit coupled to a specified node to control a voltage value of the specified node;
a current mirror circuit to copy the current produced by the current circuit and to communicate the current to the specified node; and
an inverter circuit configured to receive an input voltage value from the specified node and generate an output voltage with a value equal to at least one of a voltage value of the external voltage source when an n-channel MOSFET of the control circuit is in an off state and an other voltage value of the negative pin voltage source when the n-channel MOSFET of the control circuit is in an on state,
wherein the apparatus senses current.

14. The apparatus of claim 13 wherein a inverter circuit communicates the output voltage to a p-channel MOSFET pre-driver logic circuit.

15. The apparatus of claim 13 wherein the inverter circuit communicates the output voltage to an n-channel MOSFET pre-driver logic circuit.

16. The apparatus of claim 13 wherein the inverter circuit communicates the output voltage to a level shifter circuit.

17. The apparatus of claim 13:
wherein the inverter circuit is comprised of an inversion circuit coupled in series with a Complementary metal-oxide-semiconductor (CMOS) circuit coupled in series with an other CMOS circuit;
wherein the inversion circuit is comprised of the external voltage source, an other p-channel MOSFET, a pair of n-channel MOSFETs and the negative pin voltage source coupled in series and wherein the other p-channel MOSFET and at least one of the pair of n-channel MOSFETs are coupled to an other node coupling the CMOS circuit with the other CMOS circuit in order to improve transient response during a power ramp up mode of operation of the integrated circuit; and
wherein the CMOS circuit and the other CMOS circuit are each separately coupled to the external voltage source and the negative pin voltage source.

18. The apparatus of claim 13 wherein the control circuit is an n-channel MOSFET coupled to the core voltage source and the negative pin voltage source.

19. The apparatus of claim 13 wherein a specified node charges to a external voltage source voltage value when a core voltage value is less than a threshold value voltage required for the n-channel MOSFET of the control circuit to be in an on-state.

20. The apparatus of claim 13 wherein the specified node charges to a negative pin voltage source voltage value when the core voltage value is at least one of equivalent and greater than the threshold value voltage required for the n-channel MOSFET of the control circuit to be in an on-state.
